(19) United States
(12) Patent Application Publication
(10) Pub. No.: US 2021/0073359 A1
(43) Pub. Date: Mar. 11, 2021

(54) SECURE ONE-TIME PASSWORD (OTP) AUTHENTICATION

(71) Applicants: Michael Boodaei, Givatayim (IL); Eldan Ben-Haim, Kiryat Ono (IL)

(72) Inventors: Michael Boodaei, Givatayim (IL); Eldan Ben-Haim, Kiryat Ono (IL)

(21) Appl. No.: 16/565,534

(22) Filed: Sep. 10, 2019

(51) Int. Cl. G06F 21/31; H04L 9/30; H04L 9/08

(52) U.S. Cl. CPC G06F 21/31; H04L 9/0844; H04L 9/3073

(57) ABSTRACT

Presented herein are methods, systems and devices for authenticating a user according to a secure One Time Password (OTP), comprising generating a challenge encoding a first public key of a temporary key pair generated for use during a specific authentication process, storing a first private key of the temporary key pair, outputting the challenge to a code generation device associated with a user, receiving an OTP code derived by the code generation device from an outcome of a key agreement algorithm applied to the first public and a second private key of an authentication key pair uniquely associated with the code generation device, deriving a reference OTP code from an outcome of the key agreement algorithm applied to the first private key and a second public key of the authentication key pair, and authenticating the user according to a match between the OTP code and the reference OTP code.

### FIELD AND BACKGROUND OF THE INVENTION

The present invention, in some embodiments thereof, relates to authenticating a user using a client device for accessing a secure service, and, more specifically, but not exclusively, authenticating a user which uses a client device for accessing a secure service based on a secure OTP code generated by a code generation device associated with the user.

Access to secure online and/or offline resources is often subject to user authentication in which the user is required to provide evidence to prove his identity. Reliable authentication may be a major concern when accessing secure online services, secure systems, secure platforms and/or the like such as, for example, an online finance service (e.g. a banking service, a credit/debit card service, etc.), a remote access system, an entertainment content streaming service and/or the like. However, reliably authenticating the user may be highly important and in some cases essential also for accessing local secure services provided by a client device of the user whether online or offline. For example, some client devices may require secure login such that the user must be first positively authenticated before allowed to login and use the client device.

User authentication may be carried out by a plurality of methods, techniques and/or implementations. One of the most commonly used authentication methods is OTP in which the user is requested to provide an OTP code (e.g. a sequence of numbers and/or digits) generated and valid for a single authentication process which definitively verifies the user is who he claims to be.

In the OTP scheme, a code generation device associated with the user may generate the OTP code based on a unique secret key assigned to each user (and hence to his associated code generation device) and a challenge received from an authenticating party associated with the secure service, for example, an authentication system, an authentication application and/or the like.

The authentication system may analyze the received OTP code with respect to the secret key of the user combined with the challenge generated for the specific (current) authentication process and may thus verify the identity of the user. Since each user is associated with a unique key verifying the OTP code which is based on the user's unique key may ensure reliable authentication that the user is truly who he claims to be. Moreover, since each challenge is generated and valid for a single authentications process thus making the OTP code generated based on the challenge also valid for the single authentication process, replay attacks using an OTP code used during previous authentication process(s) may be futile.

### SUMMARY OF THE INVENTION

According to a first aspect of the present invention there is provided a computer implemented method of authenticating a user according to a secure One Time Password (OTP), comprising using one or more processors of an authentication system:
Generating a challenge encoding a first public key of a temporary key pair generated for use during a specific authentication process.
Storing a first private key of the temporary key pair.
Outputting the challenge to a code generation device associated with a user.
Receiving an OTP code derived by the code generation device from an outcome of a key agreement algorithm applied to the first public key extracted from the challenge and a second private key of an authentication key pair uniquely associated with the code generation device.
Deriving a reference OTP code from an outcome of the key agreement algorithm applied to the first private key and a second public key of the authentication key pair.
Authenticating the user according to a match between the OTP code and the reference OTP code.

According to a second aspect of the present invention there is provided an authentication system for authenticating a user according to a secure OTP, comprising a program store storing a code and one or more processors coupled to the program store for executing the stored code. The code comprising:
Code instructions to generate a challenge encoding a first public key of a temporary key pair generated for use during a specific authentication process.
Code instructions to store a first private key of the temporary key pair.
Code instructions to output the challenge to a code generation device associated with a user.
Code instructions to receive an OTP code derived by the code generation device from an outcome of a key agreement algorithm applied to the first public key extracted from the challenge and a second private key of an authentication key pair uniquely associated with the code generation device.
Code instructions to derive a reference OTP code from an outcome of the key agreement algorithm applied to the first private key and a second public key of the authentication key pair.
Code instructions to authenticate the user according to a match between the OTP code and the reference OTP code.

According to a third aspect of the present invention there is provided a computer implemented method of generating a secure OTP used for authenticating an associated user, comprising using one or more processors of a code generation device associated with a user for:
Receiving a challenge encoding a first public key of a temporary key pair generated by an authentication system for use during a specific authentication process.
Deriving an OTP code from an outcome of a key agreement algorithm applied to the first public key extracted from the challenge and a second private key of an authentication key pair uniquely associated with the code generation device.
Outputting the OTP code to the authentication system which authenticates the user according to a match between the OTP code and a reference OTP code derived from an outcome of the key agreement algorithm applied to a first private key of the temporary key pair and a second public key of the authentication key pair.

According to a fourth aspect of the present invention there is provided a code generation device for generating a secure OTP used for authenticating an associated user, comprising a program store storing a code and one or more processors coupled to the program store for executing the stored code. The code comprising:
Code instructions to receive a challenge encoding a first public key of a temporary key pair generated by an authentication system for use during a specific authentication process.
Code instructions to derive an OTP code from an outcome of a key agreement algorithm applied to the first public key extracted from the challenge and a second private key of an authentication key pair uniquely associated with the code generation device.
Code instructions to output the OTP code to the authentication system which authenticates the user according to a match between the OTP code and a reference OTP code derived from an outcome of the key agreement algorithm applied to a first private key of the temporary key pair and a second public key of the authentication key pair.

In a further implementation form of the first, second, third and/or fourth aspects, the user is granted access to one or more services in case of a successful authentication process.

In a further implementation form of the first, second, third and/or fourth aspects, the temporary key pair is invalidated after the specific authentication process is complete.

In a further implementation form of the first, second, third and/or fourth aspects, the outcome of the key agreement algorithm applied to the first private key and the second public key equals the outcome of the key agreement algorithm applied to the second private key and the first public key.

In a further implementation form of the first, second, third and/or fourth aspects, the key agreement algorithm is Ellipse Curve Diffie-Hellman (ECDH) algorithm.

In a further implementation form of the first, second, third and/or fourth aspects, the challenge is output to the code generation device by projecting a visually encoded version of the challenge via a display which is scanned by the code generation device.

In a further implementation form of the first, second, third and/or fourth aspects, the challenge is output to the code generation device by generating an audible version of the challenge via one or more audio output interfaces, the audible version is captured by the code generation device.

In a further implementation form of the first, second, third and/or fourth aspects, the OTP code is received via one or more input interfaces operated by the user to insert the OTP code generated by the code generation device.

In a further implementation form of the first, second, third and/or fourth aspects, the second public key is locally stored.

In an optional implementation form of the first, second, third and/or fourth aspects, the OTP code is generated by the code generation device in response to a successful local authentication sequence conducted between the user and the code generation device, the local authentication sequence is based on biometric authentication, verification of a code stored in an attachable storage media attached to the code generation device and/or verification of a code uniquely associated with the user received from the user operating one or more input interfaces of the code generation device.

In an optional implementation form of the first, second, third and/or fourth aspects, the challenge and the reference OTP code are generated in advance for protecting one or more locally stored protected data items associated with the code generation device, the challenge and the reference OTP code are used during a future authentication process conducted to authenticate the user for accessing one or more of the locally stored data item(s).

In a further implementation form of the first, second, third and/or fourth aspects, the locally stored protected data item(s) include a third private key associated with the code generation device and used for further authenticating the user.

In a further implementation form of the first, second, third and/or fourth aspects, one or more of the locally stored protected data item(s) are protected by storing the locally stored protected data item(s) in one or more local protected hardware resource which are accessible using the OTP code.

In a further implementation form of the first, second, third and/or fourth aspects, one or more of the locally stored protected data item(s) are protected by storing an encrypted version of the locally stored protected data item(s) encrypted using the OTP code.

In a further implementation form of the first, second, third and/or fourth aspects, the challenge is locally stored for the future authentication process and outputted to the code generation device during the future authentication process initiated in response to a user access request requiring authentication.

In a further implementation form of the first, second, third and/or fourth aspects, the challenge and the reference OTP code are discarded after the future authentication process is complete and a new challenge and a new reference OTP code are generated for protecting one or more of the locally stored protected data item(s). The new challenge and new reference OTP code are used during a subsequent future authentication process conducted to authenticate the user for accessing one or more of the locally stored data item(s).

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents flowcharts of exemplary processes executed by an authentication system and a code generation device associated with a user to authenticate the user accessing a secure service based on a secure OTP code generated by the code generation device, according to some embodiments of the present invention;

FIG. 2A and FIG. 2B are schematic illustrations of exemplary embodiments of a system for authenticating a user accessing a secure service based on a secure OTP code generated by a code generation device associated with the user, according to some embodiments of the present invention;

FIG. 3 is a schematic illustration of a sequence for authenticating a user accessing a secure service based on a secure OTP code generated by a code generation device associated with the user, according to some embodiments of the present invention; and

FIG. 4 is a schematic illustration of a sequence for accessing locally stored protected data associated with a user which are protected by a secure OTP code generated by a code generation device associated with the user, according to some embodiments of the present invention.

### DESCRIPTION OF SPECIFIC EMBODIMENTS OF THE INVENTION

The present invention, in some embodiments thereof, relates to authenticating a user using a client device for accessing a secure service, and, more specifically, but not exclusively, authenticating a user which uses a client device for accessing a secure service based on a secure OTP code generated by a code generation device associated with the user.

According to some embodiments of the present invention, there are provided methods, systems, devices and computer software programs for authenticating a user accessing one or more secure services based on a secure OTP code generated by a code generation device associated with the user. By definition, each OTP code (e.g. a sequence of numbers and/or digits) which is generated by the code generation device based on a received challenge is valid for a single authentication process and may thus be used only once.

To maintain security of the secure service(s), for example, a secure service, a secure system, a secure platform and/or the like (collectively designated secure service herein after), the user typically using a client device, for example, a Smartphone, a tablet, a smart watch, a desktop, a laptop, a proprietary client device and/or the like to access the secure service(s) may be requested to provide the OTP code which is used by an authentication system associated with the secure service(s) to authenticate the user identity, i.e. verify the user is who he claims to be.

The secure service(s) may include remote services accessible to the client device of the user over a network, for example, an online finance service (e.g. a banking service, a credit/debit card service, etc.), a remote access system, an entertainment content streaming service and/or the like. The secure service(s) may further include local services provided by the client device itself, for example, a secure login to the client device, access to protected data of the user (e.g. access credentials, passwords, codes, private data, etc.) which is locally stored in the client device and/or the like. As such, the authentication system associated with the remote secure service(s) may typically be remote and may communicate with the client device over the network. However, the authentication system associated with the local secure service(s) may be integrated and/or executed by the client device itself and may be used regardless of whether the client device is connected to the network (online) or not (offline).

The code generation device generating the OTP code may be a general purpose device such as, for example, a Smartphone, a tablet, a smart watch, a desktop, a laptop, and/or the like executing one or more software applications for generating the OTP code. Additionally and/or alternatively, the code generation device is a proprietary device specifically configured to generate the OTP code.

The code generation device is associated with an authentication key pair which is uniquely assigned to the associated user. The authentication key pair may be a cryptographic key pair, for example, an asymmetric cryptographic key, a public-key cryptographic key, an Elliptic-Curve (EC) cryptographic key and/or the like comprising a private key and a corresponding public key. The private key is kept secret and may be locally stored by the code generation device while the public key serving as an identifier of the user may be openly distributed and thus available to any interested party, in particular to the authentication system. Optionally, in order to protect the private key, the code generation device may be isolated from the network thus making it highly robust and immune to network based malicious attacks which may be launched in attempt to compromise and obtain the private key of the user.

For each authentication process, the authentication system may generate a challenge which may be used by the code generation device to generate the OTP code for the respective authentication processes. The challenge is therefore valid only for the respective authentication process and may not be used for additional authentication processes.

To produce the challenge, the authentication system may generate a temporary key pair which may also be a cryptographic key pair comprising the first public key and a corresponding (first) private key. To facilitate validity of the challenge for a single authentication process the temporary key pair is generated for each authentication process and is discarded after the authentication process ends, whether the authentication process is successful or failed.

The authentication system generates the challenge to encode the first public key of the temporary key pair and may output the challenge which may be transferred to the code generation device. As the code generation device is isolated from the network and is typically independent of the client device, the challenge may be presented to the code generation device using the client device used by the user to access the secure service(s).

The client device may present the challenge to the code generation device using one or more channels, in particular one-way channels which may optionally be tamper resistant to ensure that data transmitted via this interface(s) may not be altered and/or manipulated. This channel(s) may include, for example, a display of the client device operated to present a visually encoded version of the challenge, for example, a QR code, a barcode and/or the like which may be scanned by a scanner of the code generation device configured to scan visual data. In another example, the channel(s) may include an audio output (e.g. speaker) of the client device operated to output an audio version of the challenge (within the audible sound spectrum or beyond it, e.g. ultrasonic spectrum) which may be captured by one or more audio input interfaces (e.g. microphone) configured to capture audio and/or sound. In another example, the challenge may be encoded as a string which may be presented to the user by the display of the client device and/or outputted in audible version. The user serving as an intermediator may insert the challenge to the code generation device via one or more Human Machine Interfaces (HMI) (e.g. keyboard, keypad, touchscreen, microphone, etc.).

After receiving the challenge, the code generation device may apply one or more key agreement algorithms to the first public key extracted from the challenge and the (second) private key of the authentication key pair associated with the user which is privately and securely stored in the code generation device. The key agreement algorithms as known in the art, for example, the Diffie-Hellman (DH) key exchange algorithm (e.g. ECDH in case EC cryptographic keys are used) and/or the like are protocols which may be applied by two or more parties in order to agree on a key in such a way that all parties (both in case of two parties) influence the outcome. If the key agreement algorithm is properly applied, it may preclude undesired third parties from forcing a key choice on the agreeing parties. Moreover, the data exchanged between the parties applying the key agreement algorithms does not include the private keys themselves and the private keys are thus not exposed to potential eavesdropping parties which may intercept the exchanged data in attempt to compromise the private keys, in particular the second private key. Moreover, even if the exchanged data or part of it is intercepted by the eavesdropping party(s), the key agreement process itself may not be compromised and at worst case the current authentication process may fail without revealing any secret data.

The code generation device may then derive the OTP code from an outcome of the agreement algorithm(s) and may output the generated OTP code via one or more interfaces of the code generation device, for example, a display an audio output interface and/or the like. The user may then input the OTP code to the client device via one or more of the HMI interfaces of the client device, for example, the keyboard, the keypad, the touchscreen, the microphone and/or the like.

The client device may transmit the received OTP code to the authentication system. The authentication system, having the (second) public key uniquely of the authentication key pair associated with the user (and thus with the code generation device), may apply to the first private key (of the temporary key pair) and the second public key the same key agreement algorithm(s) used by the code generation device to generate the OTP code. The authentication system may then derive a reference OTP code from the outcome of the key agreement algorithm(s).

Due to the inherent characteristics of the key agreement algorithm(s), assuming the first and second private keys correspond to the first and second public keys respectively, the outcome of the key agreement algorithm(s) applied to the first private key and the second public key equals the outcome of the same key agreement algorithm(s) applied to the second private key and the first public key. Since the outcomes are equal, the OTP code derived by the code generation device and the reference OTP code derived by the authentication system from their respective outcomes are also equal.

The authentication system may compare between the received OTP code generated by the code generation device and the reference OTP code and may authenticate the user according to a match between the received OTP code and the reference OTP code. Since the user, specifically the code generation device is the only one having access to the second private key of the authentication key pair uniquely assigned to the user, the match may indicate the user possesses the correct second private key and its identity may be thus verified.

In case of successful authentication, the authentication system may indicate the user may be granted access to one or more of the secure services. Otherwise, in case of no match, the authentication system may indicate the user should be denied access to the secure service(s).

As described herein before, according to some embodiments of the present invention, authenticating the user based on the OTP code may be applied for accessing data associated with the user which are locally stored at the authentication system and protected by the OTP code. The locally stored protected data may include, for example, sensitive and/or private data of the user. In another example, the locally stored protected data may include credentials of the user, for example, a third private key, an access code, a password and/or the like which may be used for further authenticating the user accessing one or more of the secure services.

For example, assuming the client device integrating the authentication system requires a secure login in which the user must be first authenticated in order to unlock the client device for use. In such case an Operating System (OS) and/or one or more applications executed by the client device may protect the login credentials of the user which are locally stored in the client device. In order to avoid the user from typing the actual credentials for logging in and thus prevent interception of the credentials by a potential malicious party that may monitor the client device, the login may be done based on the OTP code which may allow the OS to access to the locally stored and protected credentials and use them for securely logging the user into the client device. This implementation may apply whether the client device is online and connected to the network 250 as well as when the device is offline and disconnected from the network.

The locally stored protected data may be further protected using one or more protected resources and/or protection methods. For example, the locally stored protected data and/or part thereof may be stored in one or more protected hardware resources of the client device, for example, a Trusted Platform Module (TPM), an Enclave and/or the like which may be accessed only with the OTP code. In another example, the locally stored protected data and/or part thereof may be encrypted using the OTP code such that the client device stores an encrypted version of the locally stored protected data.

In order to protect the locally stored protected data with the OTP code, the authentication system may generate the temporary key pair and derive a reference OTP and a challenge form the temporary key pair as described herein before in advance prior to an access request initiated by the user for accessing the protected data. The authentication system may store (save) the challenge for use during the future authentication process thus generating provisions for the future authentication process conducted to authenticate the user for accessing the locally stored protected data.

The authentication system may apply the reference OTP code for protecting the locally stored protected data. For example, assuming a certain locally stored protected data item is stored in the protected hardware resources of the client device, for example, the TPM, the authentication system may configure the TPM to respond to accesses to the certain locally stored protected data item only when using a respective reference OTP code created to protect the certain locally stored protected data item. In another example, the authentication system may use one or more encryption algorithms to encrypt the locally stored protected data with the reference OTP code such that the encrypted locally stored protected data item(s) may be decrypted only with the reference OTP code.

The authentication system may discard (delete, remove, erase) the reference OTP code and the temporary key pair used to produce the reference OTP such that the locally stored protected data item(s) may not be accessible by anyone except for the user who is the only one that may reproduce the reference OTP code.

During the future authentication process, in response to an access request initiated by the user for accessing the locally stored protected data, the authentication system may output the stored challenge which may be transferred to the code generation device. The code generation device may apply the key agreement protocol(s) to the first public key extracted key from the challenge and the second private key as described herein before and may further derive an OTP code from the outcome of the key agreement algorithm.

The OTP code may be transferred to the authentication system, for example, by the user typing the OTP code into the client device which may transfer the OTP code to the authentication system whether remote and/or local.

Using the OTP code received from the code generation device the authentication system may access the locally stored protected data. In case the OTP code successfully reproduces the reference OTP which was initially applied to protect them, the locally stored protected data may be retrieved. In case the OTP code does not correctly reproduce the reference OTP which indicates the OTP code was not generated using the correct second private key, the locally stored protected data may be inaccessible and may thus not be retrieved.

After the authentication process is complete the authentication system discards the challenge which is thus invalid for any further authentication processes to prevent replay attacks. Moreover, the authentication system may generate a new reference OTP and a new challenge based on a newly generated temporary key pair. The new reference OTP may be used for re-protecting the locally stored protected data while the new challenge may be stored for a subsequent future authentication process conducted in response to another access request initiated by the user.

The secure OTP based authentication may present major benefits and advantages over currently existing methods and systems for user authentication, specifically OTP based authentication systems.

Some of the existing authentication systems are based on storing the secret key assigned to the users and authenticating the users by comparing the OTP code provided by the user which is generated based on the secret key of the user with a reference OTP code generated based on the stored copy of the user's secret key. Since the authentication systems are connected to network(s) they may be highly exposed, and/or vulnerable to a plurality of network based security threats and risks which may compromise the locally stored secret keys of the users. The secure OTP based authentication system on the other hand does not locally store the secret key, i.e. the private key of the users but rather only the public key of the users which is meant to be openly distributed to become common knowledge. Therefore, even if the authentication system is compromised, the private keys of the users cannot be obtained from it. In addition, the users' secret keys locally stored in the existing authentication systems may be exposed to operators having access to the authentication system storage who may thus gain access to the stored secret keys. This threat is also eliminated in the secure OTP based authentication system which may further ensure non-repudiation since none of the operators may be accused of generating the OTP code using the locally stored secret keys as may be the case in the existing authentication systems.

Moreover, in some of the existing authentication systems the secret (private) key of the user may be extracted, derived and/or inferred from the data exchanged between the user and the authentication system. A malicious party monitoring and intercepting the exchanged data may therefore be able to identify (e.g. extract, derive, infer) and compromise the user's secret key. In contrast, the data exchanged between the authentication system, typically via the client device and the code generation device does not contain the private key of the user. Therefore, even if the exchanged data is intercepted, the private key of the user cannot be extracted from it. Moreover, since the actual private key of the user is not openly transferred and may thus not be intercepted there is no need for securing and/or encrypting the exchanged data as may be done by the existing authentication systems. This may significantly simplify the authentication process and reduce cost and/or complexity of the devices involved in the authentication process, i.e., the code generation device and/or of the client device.

Furthermore, while the private key of the user is privately stored in his associated code generation device and not transferred to the authentication system, the user may still be deterministically identified and authenticating using the key agreement algorithm(s). This is because of the inherent characteristics of the key agreement algorithms which may produce equal outcomes when applied to a first set of the private and public keys (e.g. the first private key and the second public key) and to a second set of the private and public keys (e.g. the second private key and the first public key) assuming the private keys correspond to their respective public keys.

In addition, since the challenge and the respective OTP code generated using the challenge are valid for a single authentication process, the authentication process is immune to replay attacks initiated by potential malicious party(s) attempting to use OTP code(s) intercepted during previous authentication process(s) to fraudulently impersonate as the user.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

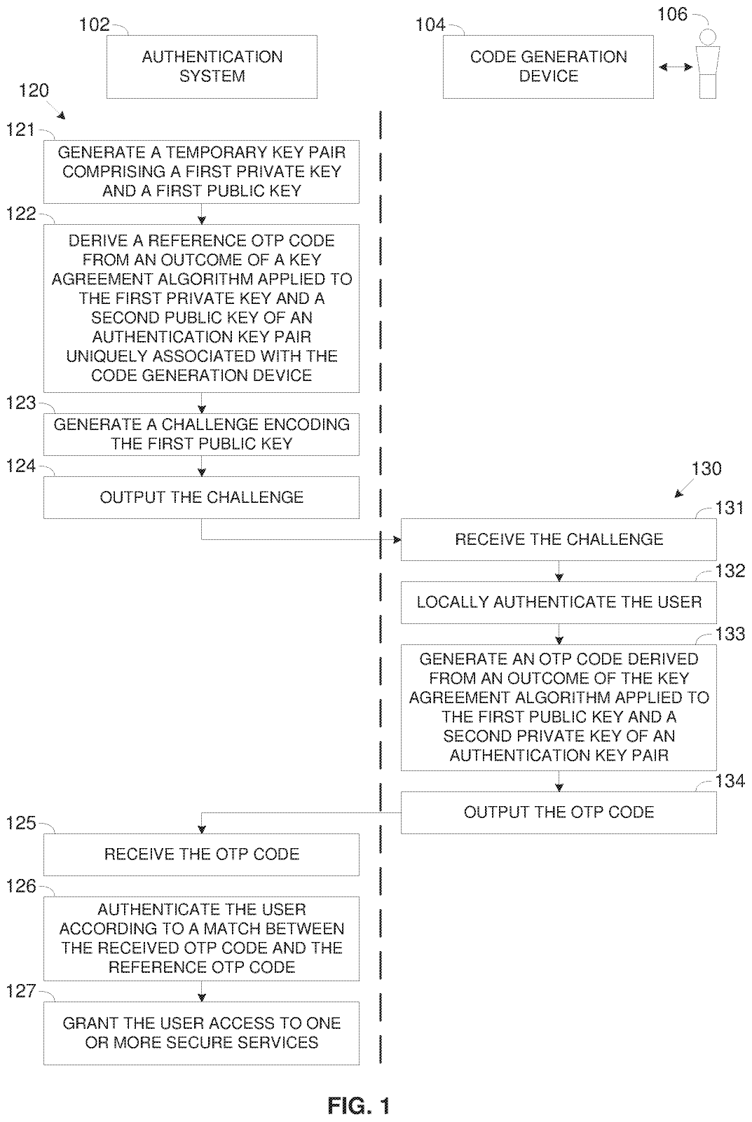

Reference is now made to FIG. 1, which presents flowcharts of exemplary processes executed by an authentication system and a code generation device associated with a user to authenticate the user accessing a secure service based on a secure OTP code generated by the code generation device, according to some embodiments of the present invention. An exemplary process 120 may be executed by an authentication system 102 to authenticate user 106 accessing one or more secure services. The authentication process is based on a verifying a secure OTP code generated by a code generation device 104 associated with the user 106. The code generation device 104 may execute an exemplary process 130 to generate the OTP code based on a challenge generated by the authentication system 102.

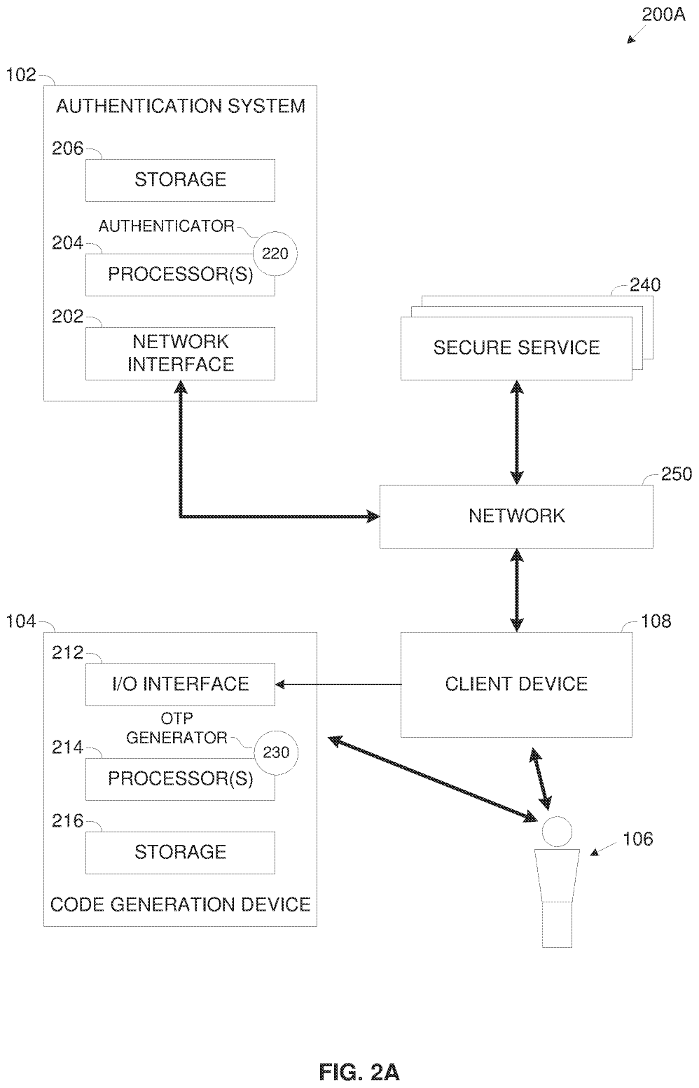

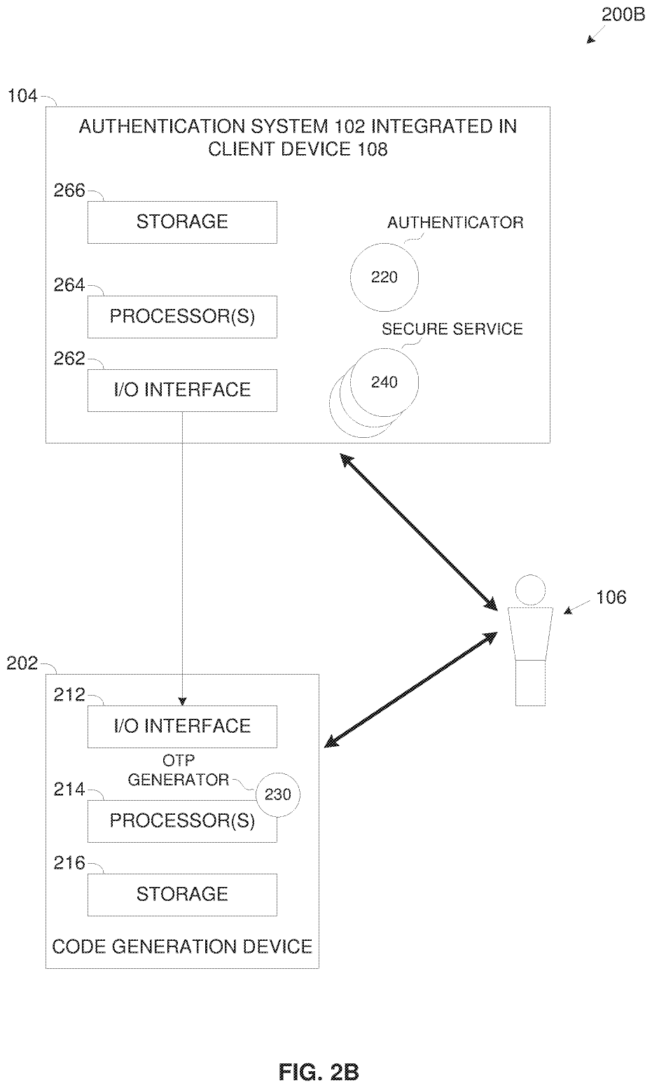

Reference is also made to FIG. 2A and FIG. 2B, which are schematic illustrations of exemplary embodiments of a system for authenticating a user accessing a secure service based on a secure OTP generated by a code generation device associated with the user, according to some embodiments of the present invention.

As seen in exemplary system 200A, a user such as the user 106 associated with a code generation device such as the code generation device 104 may use a client device 108, for example, a Smartphone, a tablet, a smart watch, a desktop, a laptop, a proprietary client device and/or the like to access one or more secure services 240. The secure service(s) 240 may be associated with a remote authentication system 102 deployed to authenticate the user 206, i.e. to validate identity of the user 106 before granting him access to the secure service(s) 240.

The secure service 240 may include, for example, a secure service, a secure system, a secure platform and/or the like to which the user 106 may be granted remote access, for example, an online finance service (e.g. a banking service, a credit/debit card service, etc.), a remote access system, an entertainment content streaming service and/or the like. The secure service 240 may be utilized by, for example, a server, a computing node, a cluster of computing nodes, a cloud service, cloud platform, cloud application and/or the like connected to the network 250.

The client device 108 may communicate with the secure service(s) 240 via a network 250 comprising one or more wired and/or wireless networks, for example, a Local Area Network (LAN), a Wide Area Network (WAN), a Metropolitan Area Network (MAN), a cellular network, the internet and/or the like.

The code generation device 104 may be a general purpose device such as, for example, a Smartphone, a tablet, a smart watch, a desktop, a laptop, and/or the like. Such a general purpose device may execute one or more software applications for generating an OTP code. Additionally and/or alternatively, the code generation device 104 is a proprietary device specifically configured to generate the OTP code.

While in some constellations the code generation device 104 may be integrated with the client device 108, typically the code generation device 104 is independent and separate from the client device 108. Moreover, the code generation device 104 is optionally disconnected and isolated from the network 250.

The code generation device 104 is associated with an authentication key pair which is uniquely assigned to the user 106. The authentication key pair may be a cryptographic key pair, for example, an asymmetric cryptographic key, a public-key cryptographic key, an Elliptic-Curve (EC) cryptographic key and/or the like comprising a private key and a corresponding public key. The private key is kept secret and may be locally stored by the code generation device 104 while the public key which serves as an identifier of the user 106 may be openly distributed and thus available to any interested party.

Optionally, in order to protect the private key stored in the code generation device 104, the code generation device 104 may be isolated from the network thus making it highly robust and immune to network based malicious attacks which may be launched in attempt to compromise and obtain the private key of the user 106.

Communication between the code generation device 104 and the client device 108 may be done via one or more tamper-resistant interfaces which may be subject to eavesdropping and/or interception by a third party(s) but ensure data integrity in the sense that transferred data may not be altered and/or manipulated. Such interfaces integrated in the code generation device 104 and/or the client device 108 may include output interfaces, for example, a display for projecting visual data, an audio output interface (e.g. speaker) for outputting audible data and/or the like. Respective input interfaces may be integrated in the other device (i.e., the code generation device 104 and/or the client device 108), for example, a scanner for scanning visual data projected on the display, an audio input interface (e.g. microphone) for capturing audible data generated by the audio output interface and/or the like. The code generation device 104 and/or the client device 108 may further include one or more HMI interfaces allowing the user 106 serving as an intermediator to input into one device data outputted by the other device.

The authentication system 102 associated with the secure service 240 may be adapted to authenticate the OTP code received from the client device 106 used by the use 106 to access the secure service(s) 240. The authentication system 102 may comprise a network interface 202 for connecting to the network 250, a processor(s) 204 for executing the process 120 to authenticate the OTP code received from the client device 108 and storage 206 for storing data and/or code (program store).

The network interface 202 may include one or more wired and/or wireless network interfaces for connecting to the network 250 to communicate with the secure service(s) 240 and/or one or more client devices 108.

The processor(s) 204, homogenous or heterogeneous, may include one or more processing nodes arranged for parallel processing, as clusters and/or as one or more multi core processor(s). The storage 206 may include one or more non-transitory persistent storage devices, for example, a Read Only Memory (ROM), a Flash array, a hard drive and/or the like. The storage 206 may also include one or more volatile devices, for example, a Random Access Memory (RAM) component and/or the like. The storage 206 may further comprise one or more network storage devices, for example, a storage server, a Network Accessible Storage (NAS), a network drive and/or the like accessible through the network interface 202.

The processor(s) 204 may execute one or more software modules each comprising a plurality of program instructions stored in a non-transitory medium (program store) such as the storage 206 and executed by one or more processors such as the processor(s) 204. For example, the processor(s) 204 may execute an authenticator 220 software module for authenticating the user 106 using the client device 106 for accessing the secure service(s) 240. The authenticator 220 may further utilize one or more hardware elements which may be integrated in the authentication system 102, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU) and/or the like.

Optionally, the authentication system 102, specifically the authenticator 220 executed by the authentication system 102 are implemented as one or more cloud computing services, for example, an Infrastructure as a Service (IaaS), a Platform as a Service (PaaS), a Software as a Service (SaaS) and/or the like such as, for example, Amazon Web Service (AWS), Google Cloud, Microsoft Azure and/or the like.

Optionally, the authentication system 102 is integrated with one or more of the secure services 240 such that the secure service(s) 240 executes the authenticator 220.

The code generation device 104 associated with the user 106 for generating the OTP code may comprise an Input/Output (I/O) interface 212 for interacting with the user 106 and optionally with the client device 108, a processor(s) 214 for executing a process such as the process 130 and a storage 216 for storing data and/or code (program store).

The I/O interface 212 may include one or more HMI (user) interfaces for interacting with the user 240, for example, a keyboard, a touchpad, a pointing device, a touchscreen, a display, a speaker, an earphone, a microphone and/or the like. The I/O interface 212 may optionally include one or more biometric sensors and/or devices, for example, a tactile senor (for fingerprint verification), an imaging sensor (for iris and/or face recognition, etc.), a microphone (for voice recognition) and/or the like. The I/O interface 212 may also include one or more imaging sensors, for example, a camera, a scanner and/or the like for scanning one or more machine readable representations, for example, a barcode, a QR code and/or the like. The I/O interface 212 may further include one or more audio input and/or output interfaces configured to capture and/or generate respectively audible data, i.e. voice, speech, sound and/or the like.

Optionally, the I/O interface 212 includes one or more wired and/or wireless interfaces for communicating with the client device 108, for example, a Universal Serial Bus (USB), a serial interface, a Radio Frequency (RF) interface, a Near Field Communication (NFC) interface, a Wireless LAN interface (WLAN, e.g. Wi-Fi, etc.) and/or the like.

The processor(s) 214, homogenous or heterogeneous, may include one or more processing nodes arranged for parallel processing, as clusters and/or as one or more multi core processor(s). The storage 216 may include one or more non-transitory persistent storage devices, for example, a ROM, a Flash array, a hard drive and/or the like. The storage 214 may also include one or more volatile devices, for example, a RAM component and/or the like.

The processor(s) 214 may execute one or more software modules such as, for example, a process, a script, an application, an agent, a utility, a tool and/or the like each comprising a plurality of program instructions stored in a non-transitory medium (program store) such as the storage 216 and executed by one or more processors such as the processor(s) 214. For example, the processor(s) 214 may execute an OTP generator 230 software module for generating an OTP code based on a unique authentication key associated with the code generation device 104. The OTP generator 230 may further utilize one or more hardware elements which may be integrated in the code generation device 104, for example, a circuit, a component, an IC, an ASIC, an FPGA, a DSP, a GPU and/or the like.

As seen in exemplary system 200B, the authentication system 102 may be integrated in the client device 108 such that the authenticator 220 is executed by the client device 106. Such deployment and implementation may be applicable for one or more scenarios and/or applications in which the user 106 needs to be authenticated in order to access one or more secure services 240 provided by the client device 108 itself. Such secure services 240 may include, for example, accessing the client device 108 (e.g. secure login) and/or accessing one or more secure services, applications and/or tools executed by the client device 108. Moreover, the implementation form presented in the system 200B may apply when the client device 108 is disconnected from the network 250, i.e. the client device 250 is offline.

The client device 108 integrating the authentication system 102 may therefore execute the authenticator 220 for authenticating the user 106 in order to validate the identity of the user 106 attempting to access the secure service(s) 240 executed by the client device 108. As described for the authentication system 102 in the system 200A, the client device 108 may authenticate the user 106 based on an OTP code generated by the code generation device 104 associated with the user 106.

The client device 108 may include an I/O interface 266 such as the I/O interface 212, a processor(s) 264 such as the processor(s) 214 and storage 266 such as the storage 216. The processor(s) 264 may execute one or more software modules such as, for example, a process, a script, an application, an agent, a utility, a tool and/or the like each comprising a plurality of program instructions stored in a non-transitory medium (program store) such as the storage 266 and executed by one or more processors such as the processor(s) 264. For example, the processor(s) 264 may execute one or more of the secure services 240.

The authenticator 220 executed at the client device 108 may be executed and/or utilized by the general purpose resources of the client device 108, such as, for example, the processor(s) 264 and/or the storage 266. Additionally and/or alternatively, the authenticator 220 may be executed and/or utilized by one or more separate resources which may be available at the client device 108, for example, another processor(s), another storage, another hardware element(s) and/or a combination thereof.

The process 120 and the systems 200A and 200B describe a single user 106 associated with a single code generation device 104 and using a single client device 108 for accessing the secure service(s) 240. This, however, should not be construed as limiting since the process 120 executed by the authentication system 102 as described in systems 200A and 200B may be expanded to serve and authenticate a plurality of users such as the user 106 each using one or more client devices such as the client device 108 for accessing the secure service(s) 240. Each of the plurality of users 106 is associated with one or more code generation devices such as the code generation device 104 each executing the process 130.

The processes 120 and 130 are conducted for each authentication process by each user 106 using a respective client device 108 to access the secure service(s) 240. The authenticator 220 may initiate the process 120 in response to an access request received from the client device 108 used by the user 106 for accessing the secure service(s) 240. However, the authenticator 220 may execute at least part of the process 120 in advance prior to receiving the access request as described herein after in detail.

As shown at 121, the process 120 starts with the authenticator 220 generating a temporary key pair comprising a (first) private key and a (first) public key. The authenticator 220 may generate the temporary key pair according to one or more key generation protocols such as, for example, asymmetric cryptography, public-key cryptography, Elliptic-Curve (EC) cryptography and/or the like. For example, the authenticator 220 may employ the Elliptic-Curve Cryptography (ECC) system for generating the temporary key pair.

As shown at 122, the authenticator 220 may generate a reference OTP code based on the first private key of the temporary key pair and a (second) public key of the authentication key pair uniquely assigned to the user 106 and thus uniquely associated with the code generation device 104.

The authentication key pair uniquely assigned to the user 106 may be generated according to one or more of the key generation protocols, for example, the asymmetric cryptography, the public-key cryptography, the EC cryptography and/or the like, such as, for example, the ECC cryptosystem. In particular, the same key generation protocol must be used for generating the temporary key pair and the authentication key pair.

As known in the art for cryptographic key pairs, the public keys, in particular the second public key serving as identifier of the user 106, specifically an identifier of the code generation device 104 may be openly distributed and is thus common knowledge. The authenticator 220 may therefore access one or more data resources, for example, a database, a data service and/or the like via the network 250 to obtain the second public key of the authenticating key pair associated and identifying the code generation device 104. It is assumed that even if the client device 108 is offline, in particular as described in system 200B, the authenticator 220 is familiar with the second public key which may be obtained previously, for example, while the client device 108 was online and connected to the network 250, during one or more previous access requests initiated by the user 106 and/or the like.

The authenticator 220 may derive the reference OTP code from an outcome of one or more of the key agreement algorithms, for example, the Diffie-Hellman algorithm applied to the first private key and the second public key. For example, assuming the temporary key pair and the authentication key pair are EC cryptographic key pairs, the authenticator 220 may derive the reference OTP code from the outcome of Elliptic-Curve Diffie-Hellman (ECDH) key agreement algorithm applied to the first private key and the second public key.

The authenticator 220 may derive the reference OTP code from the outcome of the key agreement algorithm using one or more code derivation functions, in particular one-way code derivation functions, for example, a hash function and/or the like such that it is practically impossible to recover the first private key from the reference OTP code.

As shown at 123, the authenticator 220 may generate a challenge encoding the first public key of the temporary key pair. The authenticator 220 generates the challenge in order to deliver the first public key to the code generation device 104.

The authenticator 220 may therefore generate the challenge according to the communication channel(s) available for conveying the challenge to the code generation device 104. For example, assuming the code generation device 104 includes a scanner configured to scan visual data, the authenticator 220 may generate one or more visually encoded versions which visually encode the challenge, for example, a QR code, a barcode and/or the like. In another example, assuming the code generation device 104 includes an audio input interface (e.g. microphone) configured to capture audible data, the authenticator 220 may generate one or more audible versions of the challenge, for example, a stream of audio symbols, a sequence of characters and/or the like. In another example, assuming the code generation device 104 includes an HMI which may be operated by the user 106 to input one or more strings, the authenticator 220 may generate one or more strings encoding the challenge.

As shown at 124, the authenticator 220 may output the challenge for delivery to the code generation device 104. Naturally, in case the authenticator 220 is executed by the remote authentication system 102 as described in system 200A, the authenticator 220 may transmit the challenge to the client device 108 which may be operated to output the challenge to the code generation device 104. In case the authenticator 220 is executed by client device 108 as described in system 200B, the authenticator 220 may operate one or more interfaces of the client device 108 to output the challenge to the code generation device 104

Complementary to the generation of the challenge as describe in step 123, the challenge may be output and/or transferred to the code generation device 104 via the communication channel(s) employed for transferring data between the client device 108 and the code generation device 104. For example, in case the challenge generated by the authenticator 220 is the visually encoded version of the challenge, the display of the client device 108 may be operated to present the visually encoded version. In another example, in case the challenge generated by the authenticator 220 is the audile version of the challenge, the audio output interface (e.g. speaker) of the client device 108 may be operated to generate (play) the audible version. In another example, in case the challenge generated by the authenticator 220 is the string(s) encoding the challenge, the display of the client device 108 may be operated to present the string(s).

Since, as described herein before, the first public key does not need to be secured but may be rather openly distributed, the first public key needs no protection against eavesdropping and/or interception by third party(s) and there is therefore no need to apply any means for protecting the transfer of the challenge to the code generation device 104.

Optionally, the authenticator 220 locally stores the challenge. This may typically apply to scenarios in which the authenticator 220 generates the challenge prior to an access request of the user 106 as described herein after.

As shown at 131, the OTP generator 230 executed by the code generation device 104 may receive the challenge generated by the authenticator 220.

As described for the challenge generation and output in the process 120, reception mode of the challenge at the code generation device 104 is adapted to the form of the challenge generated by the authenticator 220. For example, in case the visually encoded version of the challenge is presented by the client device 108, the OTP generator 230 may operate a scanner of the code generation device 104 to scan the visually encoded version. In another example, in case the audible version of the challenge is outputted (played) by the client device 108, the OTP generator 230 may operate a microphone of the code generation device 104 to capture the audible version. In another example, the OTP generator 230 may receive the string(s) encoding the challenge from an HMI input interface of the code generation device 104 operated by the user 106 to input the string(s) presented by the client device 108

As shown at 132, the OTP generator 230 may locally authenticate the user 106 to verify his identity using one or more authentication methods, techniques and/or authentication measures.

For example, the OTP generator 230 may authenticate the user 106 based on biometric authentication, for example, iris recognition, face recognition, fingerprint verification, voice recognition and/or the like. The OTP generator 230 may analyze sensory data captured by one or more of the sensors of the code generation device 104 to extract one or more biometric patterns identified for the user 106 and compare the identified pattern(s) to respective reference biometric pattern(s) previously provided by the user 106 and stored in the code generation device 104. For example, the code generator 220 may analyze a fingerprint pattern of the user 240 captured by the tactile sensor of the code generation device 104 and compare it against a reference fingerprint pattern of the user 106. In another example, the code generator 220 may analyze an iris pattern and/or a face pattern of the user 106 captured by the imaging sensor of the code generation device 104 and compare them against reference iris and/or face patterns of the user 106. In another example, the code generator 220 may analyze a voice of the user 240 captured by the microphone the code generation device 104 and compare it against a reference voice pattern of the user 106.

Optionally, in order to increase security of private key stored in the code generation device 104, the private key may be stored in one or more protected hardware resources of the code generation device 104, for example, a Trusted Platform Module (TPM), an Enclave and/or the like. The code generation device 104 may be configured to enable access to the protected hardware resource storing the private key only upon successful verification of the biometric pattern(s) of the user 106. Such increased protection of the private key may be of extreme value in particular for implementations in which the code generation device 104 is utilized by the general purpose device executing a software application for generating the OTP code since the general purpose device may be connected to a network and may be therefore exposed to network based malicious cyber-attacks. Storing the private key in the protected hardware resource(s) may significantly reduce the risk of the private key being accessed and compromised by such malicious cyber-attacks.

In another example, the OTP generator 230 may authenticate the user 106 based on private data, for example, a code, a password and/or the like which is uniquely assigned to the user 106 and privately kept by the user 106 in one or more forms. For example, the user 106 may keep the private data in digital form stored in a private storage device, (e.g. memory device) which may be attached to the code generation device 104. In another example, the user 106 may keep the private data in hard copy from and type into the code generation device 104 by operating an HMI interface(s) of the code generation device 104. The code generator 220 may store an encrypted version of a code, a key and/or the like of the user 106 which may be decrypted using a code which is derived from the private data and provided by the user 106, either by attaching the attachable private storage device and/or by typing the private data via the HMI interface(s).

As shown at 133, the OTP generator 230 may generate an OTP code based on the first public key (of the temporary key pair) extracted from the challenge coupled with the second private key of the authentication key pair uniquely assigned to the user 106 and thus uniquely associated with the code generation device 104.

In particular, the OTP generator 230 may generate the OTP code in response to a successful local authentication of the user 106 as described in step 132. In case the local authentication process fails, the OTP generator 230 may abort the process 130 and not generate the OTP code. Optionally, the OTP generator 230 supports a predefined number of trials in the local authentication process and aborts after failing the predefined number of trials.

The OTP generator 230 may derive the OTP code from the outcome of one or more of the key agreement algorithms, for example, the Diffie-Hellman algorithm to the first public key and the second private key. In particular, the OTP generator 230 may apply the same key agreement algorithm(s) applied by the authenticator 220 to derive the reference OTP code as described in step 122 of the process 120. For example, assuming the temporary key pair and the authentication key pair are EC cryptographic key pairs, the OTP generator 230 may derive the OTP code from the outcome of the ECDH algorithm applied to the second private key and the first public key.

The OTP generator 230 may derive the OTP code from the outcome using the same code derivation function(s) used by the authenticator 220 to derive the reference OTP code (in step 122). For example, the OTP generator 230 may derive the OTP code from the outcome of the key agreement algorithm using one or more of the one-way code derivation functions, for example, a hash function and/or the like used by the authenticator 220 such that it is practically impossible to recover the second private key from the OTP code.

Moreover, the OTP generator 230 may derive the OTP code from the outcome of the key agreement algorithm using one or more one-way functions, for example, a hash function such that it is practically impossible to recover the second private key from the OTP code.

As shown at 134, the OTP generator 230 may output (transfer) the OTP code to the authenticator 220, in particular, to the client device 108. In case the authentication system 102 is integrated with the client device 108 as described in system 200B, the OTP code transferred to the client device 108 may be received by the authenticator 220 executed by the client device 108. In case of the remote authentication system 102 described in system 200A, the client device 108 may receive the OTP code from the OTP generator 230 executed by the code generation device 104 and forward the received OTP code via the network 250 to the authenticator 220 executed by remote authentication system 102.

The OTP generator 230 may output the OTP code to the client device 108 using one or more of the communication channels established for transferring data between the code generation device 104 and the client device 108. For example, the OTP generator 230 may operate a display of the code generation device 104 to project the OTP code to the user 106. The user 106 serving as an intermediator may input the projected OTP code to the client device 108 by operating one or more HMI interfaces of the client device 108, for example, a keyboard, a keypad, a touchscreen and/or the like. In another example, the OTP generator 230 may operate an audio output interface (e.g. speaker) of the code generation device 104 to output the OTP code in audible version which may be heard by the user 106. The user 106 may input the heard OTP code to the client device 108 by operating one or more of the HMI interfaces of the client device 108.

Optionally, the OTP code may be transferred to the client device 108 without the user 106 intermediating between them. For example, the client device 108 may capture the OTP code presented by the display of the code generation device 104 using a scanner of the client device 108 configured to scan the display of the code generation device 104. In another example, the client device 108 may capture the OTP code outputted (played) by the audio output interface of the code generation device 104 using an audio input interface (e.g. microphone) of the client device 108 configured to capture the audio generated by the code generation device 104.

Optionally, the OTP code may be transferred to the client device 108 via one or more wired and/or wireless communication channels, for example, a WLAN channel, an RF link, a USB channel and/or the like. In particular, the communication channels used for transferring the OTP code may be transmit-only unidirectional channels in which the code generation device 104 is capable of transmitting data but incapable of receiving data. As such isolation of the code generation device 104 may be ensured since data may not be injected to the code generation device 104 and it may therefore be highly immune to potential attacks initiated in attempt to compromise the code generation device 104.

The OTP code derived from the outcome of the key agreement algorithm may be derived using one or more one-way functions, for example, a hash function such that it is practically impossible to recover the second private key from the OTP code even if intercepted by a potentially malicious party(s). There is therefore no need to apply any means for protecting the transfer of the OTP code to the client device 108.

As shown at 125, the authenticator 220 may receive the OTP code generated by the OTP generator 230. The authenticator 220 may receive the OTP code via the communication channel(s) established between the code generation device 104 and the client device 108 as described in step 134 of the process 130.

Again, in case the authentication system 102 is integrated with the client device 108, the authenticator 220 executed by the client device 108 may directly receive the OTP code transferred from the code generation device 104. In case of the remote authentication system 102, the authenticator 220 may receive the OTP code via the client device 108 which receives the OTP code from the code generation device 104.

As shown at 126, the authenticator 220 may authenticate the user 106, specifically the code generation device 104 according to a match between the received OTP code generated by the OTP generator 230 and the reference OTP code generated in step 122. In case of a match, the authenticator 220 may determine that the second private key used to derive the OTP code corresponds to the second public key which identifies the user 106, specifically the code generation device 104. The authenticator 220 may therefore successfully authenticate the user 106 in case of a match. However, in case of no match, the authenticator 220 may determine that the OTP code received from the code generation device 104 is not derived from a correct second private key. The authenticator 220 may therefore fail authentication of the user 106 in case of no match.

Assuming the second private key and the second public key indeed correspond to each other (part of the same authentication key pair), due to the inherent characteristic of the key agreement algorithm(s), the outcome of the key agreement algorithm applied by the OTP generator 230 (step 133) and the outcome of the key agreement algorithm applied by the authenticator 220 (step 122) are equal. In particular, the outcome of the key agreement algorithm applied to the first private key and the second public key equals the outcome of the key agreement algorithm applied to the second private key and the first public key. Since the outcomes are equal, the OTP code derived by the OTP generator 230 and the reference OTP code derived by the authenticator 220 from their respective outcomes is also equal.

Moreover, since the temporary key pair is uniquely associated with the authentication system 102 and the authentication key pair is uniquely associated with the code generation device 104, the first private key is known only to the authenticator 220 and the second private key is known only to the OTP generator 230. Therefore, a match between the received OTP code and the reference OTP may unambiguously verify the identity of the user 106 which may be the only one that is familiar with the second private key.

Furthermore, since the key agreement algorithm does not involve transferring the private keys, the private keys may not be intercepted and/or compromised by any third party.

After the authentication process is complete, either successfully or in a failure, the authenticator 220 may discard (i.e., delete, remove, erase, etc.) the temporary key pair since it may only be used and valid for a single authentication process to prevent replay attacks initiated by potential malicious party(s) which may have intercepted the OTP code while transferred between the code generation device 104 and the client device 108.

As shown at 127, in case of successful authentication, the authenticator 220 may grant the user 106 access to one or more of the secure service(s) 240. In case of failure to authenticate the user 106, the authenticator 220 may deny access of the user 106 to the secure service(s) 240.

Granting and denying access for the user 106 to the secure service(s) 240 depends on the deployment of the authentication system 102, in particular in case of the remote authentication system 102. For example, in case the authentication system 102 is integrated in the secure service(s) 240, the authenticator 220 may directly grant or deny the user 106 access to the secure service(s) 240. However, in case the authentication system 102 is separated from the secure service(s) 240, the authenticator 220 may communicate with the secure service(s) 240 to indicate whether the user 106 may be granted or denied access.

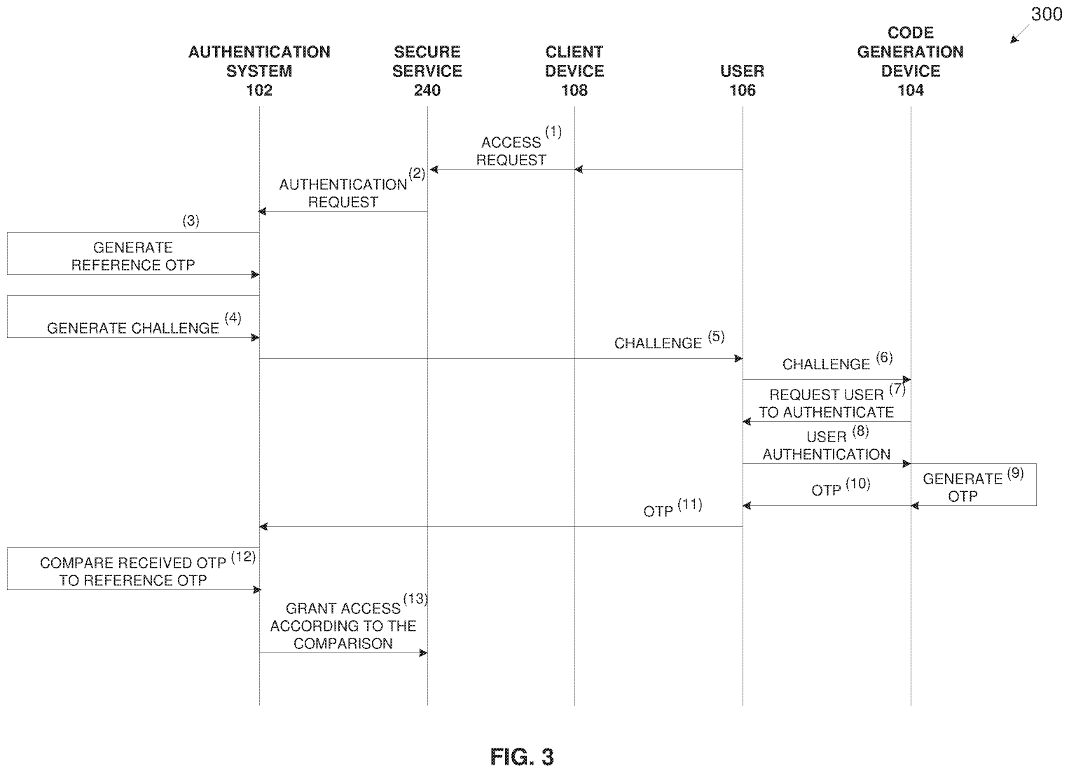

Reference is now made to FIG. 3, which is a schematic illustration of a sequence for authenticating a user accessing a secure service based on a secure OTP code generated by a code generation device associated with the user, according to some embodiments of the present invention. An exemplary sequence 300 presents a combined sequence of the processes 120 and 130 for authenticating a user such as the user 106 using a client device such as the client device 108 for accessing a secure service such as the secure service 240 based on a secure OTP generated by a code generation device such as the code generation device 104 associated with the user 106.

The sequence may typically start with the user 106 using his client device 108 to request access to the secure system 240 (1). In response, the secure service 240 may issue an authentication request (2) to an authentication system such as the authentication system 102 associated with the secure service 240. The authentication system 102, specifically an authenticator such as the authenticator 220 executed by the authentication system 102 may generate a reference OTP code (3) as described in step 122 of the process 120. The authenticator 220 may further generate a challenge (4) as described in step 123 of the process 100. The authenticator 220 may then output the challenge to the user 106 via the client device 108 (5) as described in step 124 of the process 100. The user 106 may transfer the challenge to the code generation device 104 (6) as described in step 131 of the process 130.

The code generation device 104, in particular an OTP generator such as the OTP generator 230 may locally authenticate the user 106 (7) (8) as described in step 132 of the process 130 before generating an OTP code (9) as described in step 133 of the process 130. The OTP generator 230 may then output the OTP code to the user 106 (10) which may transfer the OTP code to the authenticator 220 via the client device 108 (11) as described in step 124 of the process 120. The user 106 may transfer the challenge to the code generation device 104 (6) as described in step 131 of the process 130.

The authenticator 220 may compare between the received OTP code generated by the OTP generator 230 and the reference OTP code (12) as described in step 126 of the process 120. Based on the comparison, in case of a match the authenticator 220 may successfully authenticate the user 106 while in case of no match the authenticator 220 may fail to authenticate the user 106. Based on the comparison and the result of the authentication, the authenticator 220 may grant or deny the user 106 access to the secure service 240 (13) as described in step 127 of the process 120.

According to some embodiments of the present invention the processes 120 and 130 executed by the authenticator 220 and the OTP generator 230 respectively are conducted for authenticating the user 106 for accessing one or more data items associated with the user 106 which are locally stored at the authentication system 102 and protected by the OTP code.

The locally stored protected data item(s) may include, for example, sensitive and/or private data of the user 106. In another example, the locally stored protected data item(s) may include credentials of the user 106, for example, a third private key, an access code, a password and/or the like which may be used for further authenticating the user 106 accessing one or more of the secure services 240. The protected credentials, after released by authenticating the user 106 based on the OTP code, may be used by the authenticator 220 and/or one or more other applications, for example, an Operating system (OS) of the authentication system 102 to access one or more of secure services 240.

For example, assuming the client device 108 integrating the authentication system 102 as described in system 200B requires a secure login in which the user 106 must be first authenticated in order to unlock the client device 108 for use. In such case the OS of the client device may protect the login credentials of the user 106 which are locally stored in the client device 108. In order to prevent the user 106 from typing the actual credentials in order to login and thus prevent interception of the credentials by a potential malicious party that may monitor the I/O interfaces of the client device 108, the login may be done based on the OTP code which may allow the OS to access to the actual credentials that may be used for the secure login. Such exemplary implementations may apply whether the client device 108 is online and connected to the network 250 as well as when the device 108 is offline and disconnected from the network 250.

The locally stored protected data item(s) may be protected using one or more protected resources and/or protection methods. For example, one or more of the locally stored protected data item(s) may be stored in one or more protected hardware resources of the client device 108, for example, a TPM, an Enclave and/or the like which may be accessed only with the OTP code generated by the code generation device 104. In another example, one or more of the locally stored protected data item(s) may be encrypted using the OTP code such that the client device 108 stores an encrypted version of the locally stored protected data item(s).

In order to facilitate protection of the locally stored protected data item(s) with the OTP code, the authenticator 220 may execute steps 121, 122 and 123 of the process 120 in advance prior to any access request initiated by the user 106. This means that the authenticator 220 may generate provisions for a future authentication process conducted to authenticate the user 106 for accessing the locally stored protected data item(s).

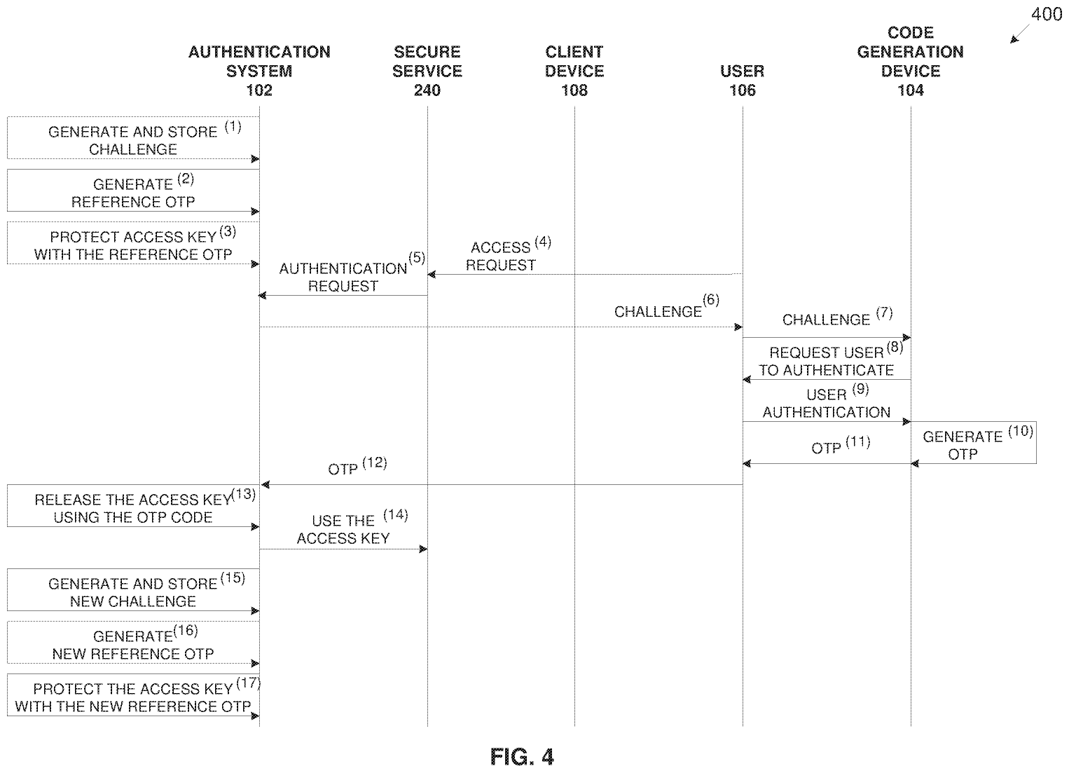

Reference is now made to FIG. 4, which is a schematic illustration of a sequence for accessing locally stored protected data associated with a user which are protected by a secure OTP code generated by a code generation device associated with the user, according to some embodiments of the present invention. An exemplary sequence 400 presents a combined sequence of the processes 120 and 130 for authenticating a user such as the user 106 using a client device such as the client device 108 for accessing one or more data items locally stored in an authentication system such as the authentication system 102 and protected by a secure OTP generated by a code generation device such as the code generation device 104 associated with the user 106.

In particular, the sequence 400 may be directed to locally stored protected data item(s) comprising an access key to one or more secure services such as the secure service 240. However, the sequence 400 should not be construed as limiting since it may be applied for accessing any type of data item(s) which are locally stored at the authentication system 102 and protected with the OTP code.

An authenticator such as the authenticator 220 may generate the temporary key pair as described in step 121 of the process 120. The authenticator 220 may further generate a challenge (1) encoding the first public key as described in step 123 of the process 120. The authenticator 220 may store (save) the challenge for use during the future authentication process.

The authenticator 220 may generate a reference OTP code (2) derived from the outcome of the key agreement algorithm applied to the first private key (of the temporary key pair) and the second public key (of the authentication key pair of the user 106) as described in step 122 of the process 120.

The authenticator 220 may then apply the reference OTP code for protecting the locally stored protected data item(s) (3). For example, assuming the locally stored protected data item(s) are stored in the protected hardware resources of the client device 108, for example, the TPM, the authenticator 220 may configure the TPM to respond to TPM accesses only when using the reference OTP code. In another example, the authenticator 220 may apply one or more encryption algorithms to encrypt the locally stored protected data item(s) with the reference OTP code such that the encrypted locally stored protected data item(s) may be decrypted only with the reference OTP code.

The authenticator 220 may discard (delete, remove, erase) the reference OTP code and the temporary key pair used to produce the reference OTP such that the locally stored protected data item(s) may not be accessible by anyone except for the user 106 who is the only one that may reproduce the reference OTP code.

During the future authentication process, in response to an access request initiated by the user 106 (4), the secure service 240 may issue an authentication request (5) to the authentication system 102 associated with the secure service 240.

The authenticator 220 may output the stored challenge (6) as described in step 124 of the process 120 which may be transferred to the code generation device (7) as described in step 131 of the process 130.

In response to the received challenge, the code generation device 104, in particular an OTP generator such as the OTP generator 230 may generate an OTP code as described in the process 130. The OTP generator 230 may first locally authenticate the user 106 (8)(9) as described in step 132 of the process 130. The OTP generator 230 may derive the OTP code (10) from the outcome of the key agreement algorithm applied to the first public key extracted from the challenge and the second private key of the authentication key pair uniquely associated with the user 106 and the code generation device 104 as described in step 133 of the process 130.

The OTP generator 230 may then output the OTP code (11) as described in step 134 of the process 130 which may be transferred via the client device 108 to the authenticator 220 (12) as described in step 125 of the process 120.

Using the OTP code received from the code generation device 104, in case the OTP code successfully reproduces the reference OTP which was initially applied to protect them, the locally stored protected data item(s) may be retrieved (13), for example, accessed in the TPM, decrypted and/or the like. However, in case the OTP code does not correctly reproduce the reference OTP which indicates the OTP code was not generated using the correct second private key, the locally stored protected data item(s) may be inaccessible and may thus not be retrieved.

The locally stored protected data item(s) may be released (retrieved) by the authenticator 220 itself and/or by one or more other applications, for example, the OS executed by the client device 108 which may receive the OTP code from the authenticator 220.

Assuming the locally stored protected data item(s) comprise the access key for the secure service 240, the released access key may be used to access the secure service 240 (14).

After the authentication process is complete the authenticator 220 discards the challenge which may not be valid for any further authentication processes to prevent replay attacks.

The authenticator 220 may then repeat steps (1), (2) and (3) to protect the locally stored protected data item(s) with a new OTP code. The authenticator 220 may generate and store a new challenge (15) generated from a new temporary key pair. The authenticator 220 may further generate a new reference OTP (16) which may be used to protect the locally stored protected data item(s) (17).

It is expected that during the life of a patent maturing from this application many relevant systems, methods and computer programs will be developed and the scope of the terms key agreement algorithms and code derivation functions are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of authenticating a user according to a secure One Time Password (OTP), comprising:
using at least one processor of an authentication system for:
generating a challenge encoding a first public key of a temporary key pair generated for use during a specific authentication process;
storing a first private key of the temporary key pair;
outputting the challenge to a code generation device associated with a user;
receiving an OTP code derived by the code generation device from an outcome of a key agreement algorithm applied to the first public key extracted from the challenge and a second private key of an authentication key pair uniquely associated with the code generation device;
deriving a reference OTP code from an outcome of the key agreement algorithm applied to the first private key and a second public key of the authentication key pair; and
authenticating the user according to a match between the OTP code and the reference OTP code.

2. The computer implemented method of claim 1, wherein the user is granted access to at least one service in case of a successful authentication process.

3. The computer implemented method of claim 1, wherein the temporary key pair is invalidated after the specific authentication process is complete.

4. The computer implemented method of claim 1, wherein the outcome of the key agreement algorithm applied to the first private key and the second public key equals the outcome of the key agreement algorithm applied to the second private key and the first public key.

5. The computer implemented method of claim 1, wherein the key agreement algorithm is Ellipse Curve Diffie-Hellman (ECDH) algorithm.

6. The method of claim 1, wherein the challenge is output to the code generation device by projecting a visually encoded version of the challenge via a display which is scanned by the code generation device.

7. The method of claim 1, wherein the challenge is output to the code generation device by generating an audible version of the challenge via at least one audio output interface, the audible version is captured by the code generation device.

8. The method of claim 1, wherein the OTP code is received via at least one input interface operated by the user to insert the OTP code generated by the code generation device.

9. The method of claim 1, wherein the second public key is locally stored.

10. The method of claim 1, further comprising the OTP code is generated by the code generation device in response to a successful local authentication sequence conducted between the user and the code generation device, the local authentication sequence is based on at least one of: biometric authentication, verification of a code stored in an attachable storage media attached to the code generation device and verification of a code uniquely associated with the user received from the user operating at least one input interface of the code generation device.

11. The method of claim 1, further comprising generating the challenge and the reference OTP code in advance for protecting at least one locally stored protected data item associated with the code generation device, the challenge and the reference OTP code are used during a future authentication process conducted to authenticate the user for accessing the at least one locally stored data item.

12. The method of claim 11, wherein the at least one locally stored protected data item is a third private key associated with the code generation device and used for further authenticating the user.

13. The method of claim 11, wherein the at least one locally stored protected data item is protected by storing the at least one locally stored protected data item in at least one local protected hardware resource which is accessible using the OTP code.

14. The method of claim 11, wherein the at least one locally stored protected data item is protected by storing an encrypted version of the at least one locally stored protected data item encrypted using the OTP code.

15. The method of claim 11, wherein the challenge is locally stored for the future authentication process and outputted to the code generation device during the future authentication process initiated in response to a user access request requiring authentication.

16. The method of claim 11, wherein the challenge and the reference OTP code are discarded after the future authentication process is complete and a new challenge and a new reference OTP code are generated for protecting the at least one locally stored protected data item, the new challenge and new reference OTP code are used during a subsequent future authentication process conducted to authenticate the user for accessing the at least one locally stored data item.

17. An authentication system for authenticating a user according to a secure One Time Password (OTP), comprising:
a program store storing a code; and
at least one processor coupled to the program store for executing the stored code, the code comprising:
code instructions to generate a challenge encoding a first public key of a temporary key pair generated for use during a specific authentication process;
code instructions to store a first private key of the temporary key pair;
code instructions to output the challenge to a code generation device associated with a user;
code instructions to receive an OTP code derived by the code generation device from an outcome of a key agreement algorithm applied to the first public key extracted from the challenge and a second private key of an authentication key pair uniquely associated with the code generation device;
code instructions to derive a reference OTP code from an outcome of the key agreement algorithm applied to the first private key and a second public key of the authentication key pair; and
code instructions to authenticate the user according to a match between the OTP code and the reference OTP code.

18. A computer implemented method of generating a secure One Time Password (OTP) used for authenticating an associated user, comprising:
using at least one processor of a code generation device associated with a user for:
receiving a challenge encoding a first public key of a temporary key pair generated by an authentication system for use during a specific authentication process;
deriving an OTP code from an outcome of a key agreement algorithm applied to the first public key extracted from the challenge and a second private key of an authentication key pair uniquely associated with the code generation device; and
outputting the OTP code to the authentication system which authenticates the user according to a match between the OTP code and a reference OTP code derived from an outcome of the key agreement algorithm applied to a first private key of the temporary key pair and a second public key of the authentication key pair.

19. A code generation device for generating a secure One Time Password (OTP) used for authenticating an associated user, comprising:
a program store storing a code; and
at least one processor coupled to the program store for executing the stored code, the code comprising:
code instructions to receive a challenge encoding a first public key of a temporary key pair generated by an authentication system for use during a specific authentication process;
code instructions to derive an OTP code from an outcome of a key agreement algorithm applied to the first public key extracted from the challenge and a second private key of an authentication key pair uniquely associated with the code generation device; and
code instructions to output the OTP code to the authentication system which authenticates the user according to a match between the OTP code and a reference OTP code derived from an outcome of the key agreement algorithm applied to a first private key of the temporary key pair and a second public key of the authentication key pair.
